(19) United States
(12) Patent Application Publication
(10) Pub. No.: US 2024/0333318 A1
(43) Pub. Date: Oct. 3, 2024

(54) COMMUNICATION CIRCUIT, CORRESPONDING SYSTEM AND METHOD

(71) Applicant: STMicroelectronics International N.V., Geneva (CH)

(72) Inventors: Nunzio Spina, Catania (IT); Giuseppe Palmisano, S. Giovanni La Punta (CT) (IT)

(21) Appl. No.: 18/612,222

(22) Filed: Mar. 21, 2024

(30) Foreign Application Priority Data
Mar. 27, 2023 (IT) 102023000005733

(51) Int. Cl. H04B 1/00

(52) U.S. Cl. CPC H04B 1/006; H04B 1/0078

(57) ABSTRACT

A circuit for transmitting/receiving signals through a galvanic isolation comprises an antenna transmitting/receiving radiofrequency signals modulated over a radiofrequency carrier, a transmitter receiving an input data signal, and a receiver delivering an output data signal. First and second capacitive circuitry are arranged between the antenna and the receiver and the transmitter, respectively. First and second switching circuitry couple the first and second capacitive circuitry to the antenna in an inductive-capacitive network, alternately: in a transmission mode, the first switching circuitry couples the first capacitive circuitry to ground with the receiver disabled, and the second switching circuitry decouples the second capacitive circuitry from the inductive-capacitive network with the transmitter enabled, and in a reception mode, the first switching circuitry decouples the first capacitive circuitry from ground, with the receiver enabled, and the second switching circuitry couples the second capacitive circuitry to the inductive-capacitive network with the transmitter disabled.

### CROSS-REFERENCE TO RELATED APPLICATIONS

This application claims the priority benefit of Italian Patent Application No. 102023000005733, filed on Mar. 27, 2023, entitled “Communication circuit, corresponding system and method,” which is hereby incorporated herein by reference to the maximum extent allowable by law.

### TECHNICAL FIELD

The description relates to communication technology.

Embodiments as described herein can be applied to communication using galvanic isolation.

### BACKGROUND

Galvanic isolation is used in a variety of applications including, by way of example, gate drivers, galvanically isolated interfaces, medical equipment, data communications, or sensor networks.

Gate drivers, for MOSFET, SiC and GaN-based power circuits and/or isolated gate drivers for electric motor control are exemplary of particularly attractive fields of application.

A communication link using galvanic isolation can be based on a pair of (micro) antennas operating in LC resonance conditions centered at the frequency of a RF carrier.

Bidirectional communication may thus involve two (distinct) separate physical links transmitting in opposite directions in a half/full duplex arrangement, which generally requires twice the silicon area used by a single physical link.

### SUMMARY

An object of one or more embodiments is to contribute in overcoming such a constraint.

According to one of more embodiments, that object is achieved with a communication circuit as set forth in the claims that follow.

One or more embodiments relate to a corresponding system.

One or more embodiments relate to a corresponding method.

The claims are an integral part of the technical teaching on the embodiments as provided herein.

One or more embodiments facilitate providing a half-duplex link, suited for use, for instance, in intra-chip communications.

Various embodiments facilitate using (only) two near-field-coupled (micro) antennas and four couples of switches to configure a direction of communication. Opening and closing (that is, making non-conductive and conductive) the switches alternately facilitate selecting matching operating conditions of a circuit for reception or transmission of a signal with respect to an antenna.

Various embodiments do not require external or non-standard components and are suited, for instance, for integration using otherwise conventional CMOS technology.

Various embodiments facilitate implementing a half-duplex communication using only one physical link.

Various embodiments lend themselves to being applied advantageously in a data interface.

### BRIEF DESCRIPTION OF THE DRAWINGS

One or more embodiments will now be described, by way of example only, with reference to the annexed figures, wherein:

FIG. 1 is generally illustrative of communication between two circuits using a galvanic isolation barrier;

FIGS. 2 and 3 are illustrative of possible contexts of application of solutions as described herein;

FIGS. 4A and 4B are exemplary of distinct, separate physical links that transmit in opposite directions;

FIG. 5 is exemplary of a single link, where input/output signals are exchanged as an RF signal in both directions;

FIG. 6 is a circuit diagram of a possible embodiment of the present description;

FIG. 7 provides further details of parts of the circuit diagram of FIG. 6; and

FIG. 8 is a possible diagram of a system incorporating embodiments of the present description.

Unless otherwise indicated, corresponding numerals and symbols in different figures generally refer to corresponding parts.

The figures are drawn to clearly illustrate the relevant aspects of the embodiments and are not necessarily drawn to scale.

The edges of features drawn in the figures do not necessarily indicate the termination of the extent of the feature.

For simplicity and ease of explanation, throughout this description, and unless the context indicates otherwise, like parts or elements are indicated in the various figures with like reference signs, and a corresponding description will not be repeated for each and every figure.

Also, throughout this description, a same designation may be used for brevity to designate:
a certain node or line as well as a signal occurring at that node or line, and/or
a certain component (for instance, a capacitor or a resistor) as well as an electrical parameter thereof (for instance, capacitance or resistance/impedance).

### DETAILED DESCRIPTION OF ILLUSTRATIVE EMBODIMENTS

In the ensuing description, various specific details are illustrated in order to provide an in-depth understanding of various examples of embodiments according to the description. The embodiments may be obtained without one or more of the specific details, or with other methods, components, materials, etc. In other cases, known structures, materials, or operations are not illustrated or described in detail so that various aspects of the embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment”, “in one embodiment”, or the like, that may be present in various points of the present description do not necessarily refer exactly to one and the same embodiment. Furthermore, particular configurations, structures, or characteristics may be combined in any adequate way in one or more embodiments.

The headings/references used herein are provided merely for convenience and hence do not define the extent of protection or the scope of the embodiments.

By way of background, document U.S. Pat. No. 8,364,195 B2 discloses a wireless galvanic isolator device formed by a transmitter circuit, a receiver circuit, and a wireless coupling structure, arranged between the transmitter circuit and the receiver circuit. The wireless coupling structure is formed by a pair of antennas each arranged on an own die and integrated together with the respective transmitter and receiver circuit. The two dice may be arranged adjacent to each other in a planar configuration or arranged on top of each other and bonded together.

Such an arrangement may facilitate data transfer through magnetically coupled planar (micro) antennas using an On-Off Keying, OOK modulated radio-frequency, RF carrier along with inherent high galvanic isolation rating (higher than >10 kV) via the spacing between dice without any special dielectric material being involved. Very low coupling parasitics facilitate obtaining inherent high immunity to common-mode transient disturbances (higher than 200 kV/μs).

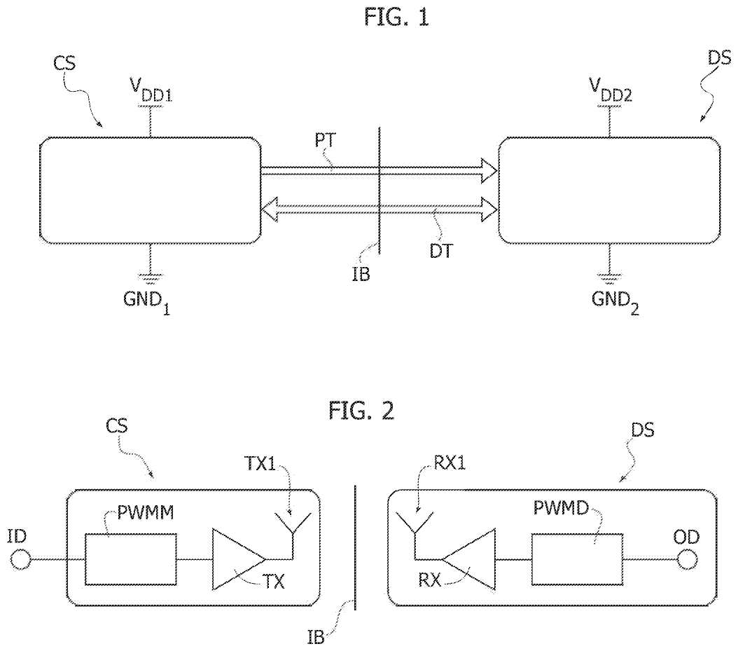

Such an arrangement is generally exemplary of communication between two circuits CS and DS through a galvanic isolation barrier IB (a transformer, for instance) as illustrated in FIG. 1.

That figure (reproduced from Italian patent application No. 102023000000495-“Receiver circuit, corresponding system and method”-Spina, Castorina and Palmisano, Inventors—not yet available to the public at the time the present application is filed) shows a first circuit CS with a supply voltage V_{DD1} and a (first) ground GND₁; the second circuit DS has a supply voltage V_{DD2} and a (second) ground GND₂. The voltage V_{DD1} may be different from the voltage V_{DD2} and the ground GND₁ may be different from the ground GND₂, with possible ground shifts.

Communication as represented by the arrows in FIG. 1 can involve power transfer PT (for instance, from the circuit CS to the circuit DS) and/or data transfer DT (for instance, from the circuit CS to the circuit DS and vice-versa).

The circuit CS may comprise, by way of example, human/data interfaces, bus/network controllers, microcontroller units (MCUs).

The circuit DS may comprise, again by way of example, sensor interfaces, gate drivers, intelligent power switches medical devices, a communication network.

Again, merely by way of example, a single-channel galvanic isolated gate driver can be used across a range of switching topologies to control power switches such as silicon-carbide (SiC) or silicon MOSFET transistors and IGBT insulated-gate bipolar transistors.

FIG. 2 (likewise reproduced from the Italian patent application already referred to in the foregoing) is illustrative of a possible context of application, wherein the circuits CS and DS are (integrated circuit) semiconductor chips or dice and communication between the two chips CS and DS involves transmitting input data ID from the chip CS towards the chip DS to be recovered as output data OD.

As noted, this is just a non-limiting example in so far as communication between the two chips CS and DS may involve transmitting data ID from the chip DS towards the chip CS, or communication in both directions.

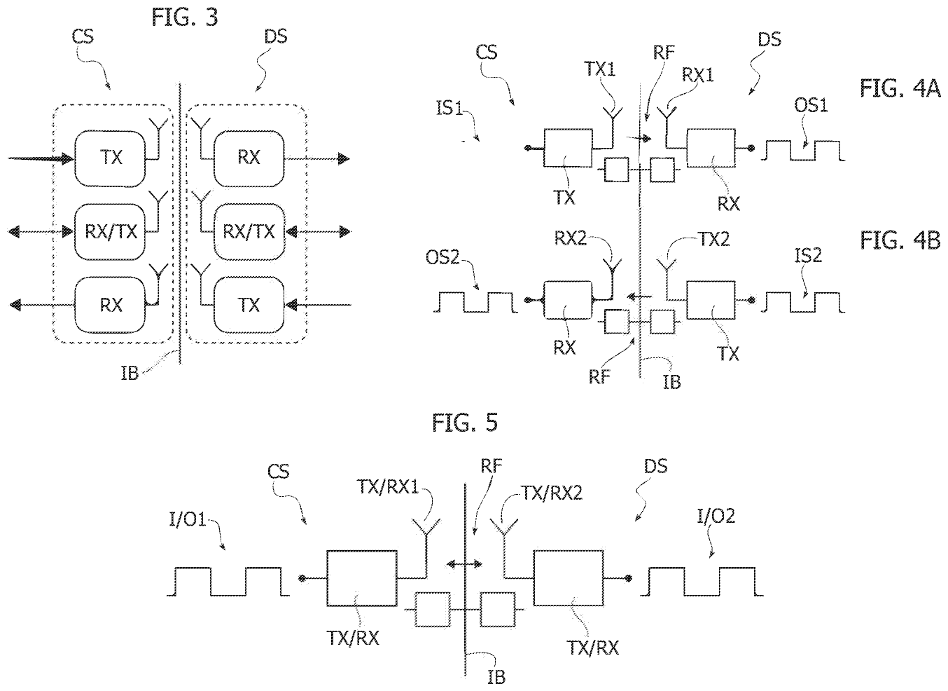

For instance, as illustrated in FIG. 3, systems can be devised (suited for implementation via Assignee's Bipolar-CMOS-DMOS, BCD technology for power integrated circuits, ICs) where communication between the two chips CS and DS via a galvanic barrier IB involves, by way of example:
a pulse-width modulated, PWM driver link (for instance, with a 1.4 GHz RF carrier, at the top of the figure) from the chip CS (here transmitter TX) to the chip DS (here receiver RX);
a bidirectional diagnostic data link (for instance, with a 0.5 GHz RF carrier, at the center of the figure) between the chip CS and the chip DS (here capable of acting each both as transmitter TX and as receiver RX); and
a power control link (for instance, with a 1.4 GHz RF carrier, at the bottom of the figure) from the chip DS (here transmitter TX) to the chip CS (here receiver RX).

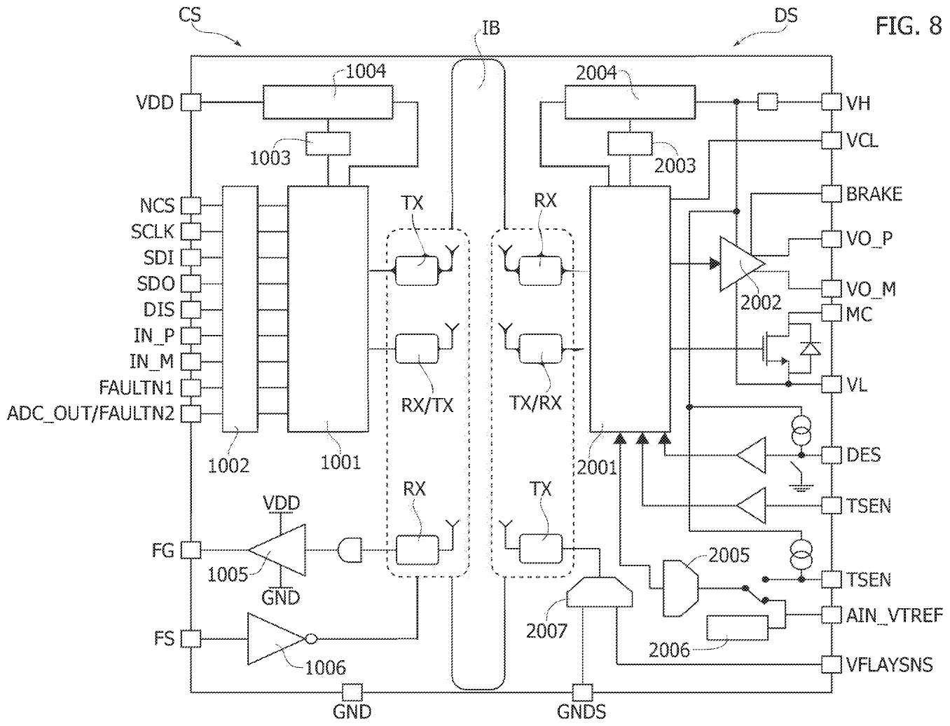

A system as illustrated by way of example in FIG. 3 (and further discussed in connection with FIG. 8) can be used to provide a 3-channel galvanic isolation interface between a controller chip CS and a driver chip DS controlled by the controller chip CS.

An arrangement as illustrated can provide reinforced galvanic isolation (higher than 10 kV) for interfaces, not bound to a specific integration technology, thus overcoming drawbacks inherent in certain conventional galvanic isolation solutions based on transformers, capacitor or optocouplers.

FIGS. 4A and 4B are exemplary of a possible implementation of a communication link based on a pair of (micro) antennas operating in LC resonance conditions centered at the frequency of a RF carrier.

As represented in FIGS. 4A and 4B, implementing bidirectional communication involves two distinct, separate physical links, that transmit in opposite directions, namely:
a first link, where a (first) input signal IS1 applied to a transmitting antenna TX1 via a transmitter TX is transmitted as an RF signal (from left to right in FIG. 4A) to a receiving antenna RX1 and forwarded to a receiver RX to produce a (first) output signal OS1; and
a second link, where a (second) input signal IS2 applied to a transmitting antenna TX2 via a transmitter TX is transmitted as an RF signal (from right to left in FIG. 4B) to a receiving antenna RX2 and forwarded to a receiver RX to produce a (second) output signal OS2.

Such a half/full duplex communication link involves using twice of the silicon area used by a single physical link.

A system using a single physical link to support bi-directional half duplex inter-chip communication would thus be desirable as represented in FIG. 5.

This figure shows a single link, where input/output signals I/O1 and I/O2 are exchanged as RF signals (in both directions, namely either from left to right and from right to left in FIG. 5) via transmitting/receiving antennas TX/RX1 and TX/RX2 and associated transmitter/receivers (transceivers) TX/RX.

Such a result can be achieved in an RF communication system using a simple circulator or a directional coupler to share an RF communication antenna with transmitter and receiver circuits in order to implement a Simultaneous Transmit And Receive, STAR arrangement on a same antenna. A circulator can be replaced with a directional coupler that gives more isolation with a loss of sensitivity in the receiver.

Another possible option is active cancellation of the transmit signal in the receiver path.

In the case of a capacitive isolation barrier, switches can be used to connect/disconnect a transmitter circuit and a receiver circuit alternately without however the advantages of a LC resonant or matching network in the transmitter circuit and the receiver circuit.

An issue with that approach lies in that the transmission system operates with a resonant LC network where the inductive portion is provided by the antenna (transmitting and receiving, respectively). Introducing other components entails a change of the resonance conditions which may result in undesired attenuation of the (voltage) signal at the receiver input.

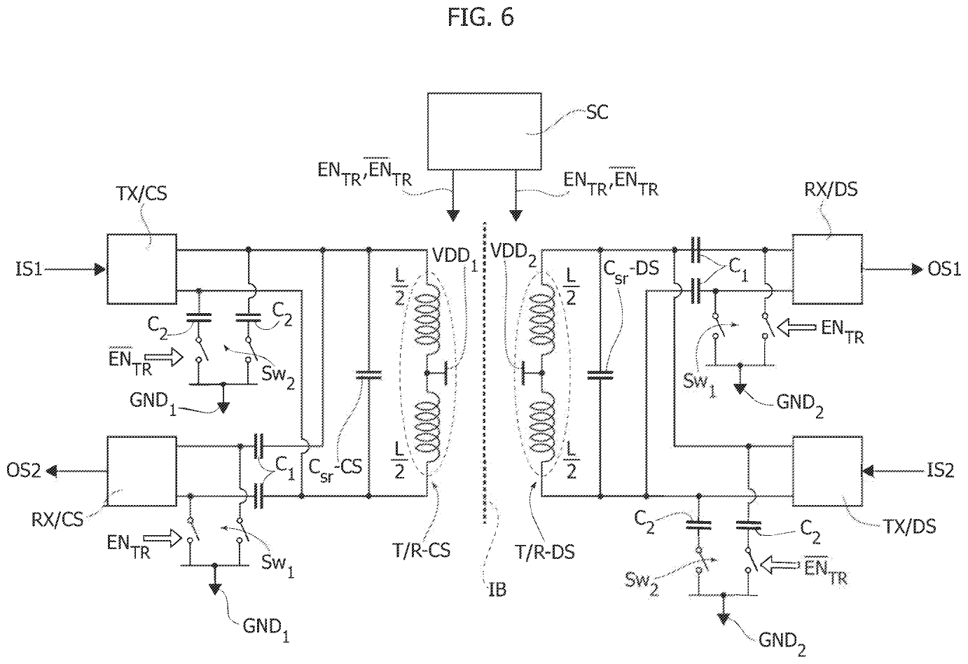

FIG. 6 is a circuit diagram of a possible embodiment according to the present description.

Again, merely by way of example, a galvanic isolation interface IB is illustrated in FIG. 6 between, for instance, a controller chip CS (u-controller side) and, for instance, a driver chip DS (driver side) controlled by the controller chip CS.

In the diagram of FIG. 6:
TX-CS and RX-CS indicate transmitter and receiver circuitry coupled to a (micro) antenna T/R-CS in the chip CS (u-controller side); and
TX-DS and RX-DS indicate transmitter and receiver circuitry coupled to a (micro) antenna T/R-DS in the chip DS (driver side).

FIG. 6 is exemplary of a single link (along the lines of FIG. 5) where input/output signals are exchanged as an RF signal (in both directions, namely either from left to right and from right to left in FIG. 6) via transmitting/receiving antennas T/R-CS, T/R-DS and associated transmitters/receivers, namely:
input signals IS1 at the chip CS (controller side) are applied to a transmitter TX/CS and then to the antenna T/R-CS to be received at the chip DS (driver side) via the antenna T/R-DS and output from the chip DS (driver side) as output signals OS1 from a receiver RX/DS; and
input signals IS2 at the chip DS (driver side) are applied to a transmitter TX/DS and then to the antenna T/R-DS to be received at the chip CS (controller side) via the antenna T/R-CS and output at the chip CS (controller side) as output signals OS2 from a receiver RX/DS.

As illustrated-merely by way of example—in FIG. 6 the (mutually coupled) antennas T/R-CS and T/R-DS can be regarded as a balanced series arrangements of two inductors having an inductance value L/2 (half of the inductance of the whole antenna totaling to a value L) with an intermediate node at a respective supply voltage V_{DD1}, V_{DD2}.

It is again noted (see also FIG. 1) that the voltage V_{DD1} may be different from the voltage V_{DD2} and the ground GND₁ of the chip CS may be different from the ground GND₂ of the chip DS, with possible ground shifts.

As illustrated-merely by way of example—in FIG. 6, the (mutually coupled) antennas T/R-CS and T/R-DS are configured as LC (inductive-capacitive) resonant circuits with capacitances Csr-CS and Csr-DS coupled across (that is, in parallel to) the antennas T/R-CS and T/R-DS.

In the diagram of FIG. 6:
the transmitters TX-CS and TX-DS have output nodes (directly) coupled across resonant circuits formed by the parallel arrangement of the antennas T/R-CS, T/R-DS and the capacitances Csr-CS and Csr-DS;
the receivers RX/CS and RX/DS have input nodes coupled-via respective capacitors C1—to the opposed ends of the resonant circuits formed by the parallel arrangement of the antennas T/R-CS, T/R-DS and the capacitances Csr-CS and Csr-DS;
first switches S_{w1} are provided that, when closed (namely, made conductive), couple to ground GND₁, GND₂ the input nodes of the receivers RX/CS and RX/DS; and
second switches S_{w2} are provided that, when closed (namely, made conductive), couple the output nodes of the transmitters TX/CS and TX/DS to respective capacitors C2 referred to ground GND₁, GND₂.

The switches S_{w1}, S_{w2} can be implemented as electronic switches such as MOSFET transistors configured, when “on”, to have the source-drain current flow path therethrough made conductive.

A same designation is used for the capacitors C1, C2 and the switches S_{w1}, S_{w2} on both the controller side (chip CS) and the driver side (chip DS) of the link.

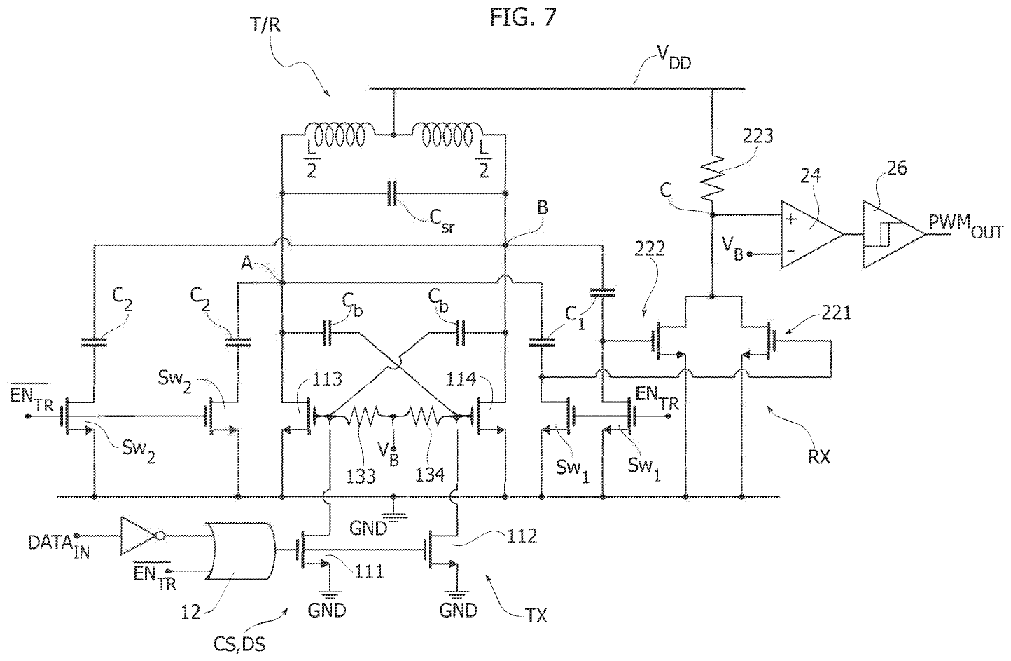

This is both for simplicity (also in connection with FIG. 7, showing that-according to embodiments of the present description-a same circuitry that can be used on both sides) and to highlight that identical components can be used advantageously (but not in a mandatory manner) on both sides.

Switching of the switches S_{w1}, S_{w2} is controlled via a switch control signal EN_{TR} that is produced (in manner known per se to those of skill in the art) in a signal generator SC and made available—in direct form EN_{TR} or in a logically complemented form (NEG) EN_{TR} to the switches S_{w1} and S_{w2}.

It is noted that the switch control signal—in direct form EN_{TR} and logically complemented form (NEG) EN_{TR}—can be assumed to be available to both chips CS and DS as parts of a same system (see also FIG. 8), without transmission between the two being required.

For simplicity of explanation (and merely by way of example), one may assume that the (bidirectional) link of FIG. 6 is configured by default to transmit from the chip DS (driver side) to the chip CS (controller side), that is with the transmitter TX/DS on the driver side and the receiver RX/CS controller side both active, namely “on”.

In this operating condition (transmission from the driver side DS to the controller side CS) the generator SC applies the signals EN_{TR} and (NEG) EN_{TR} to the switches S_{w1} and S_{w2} such that:
on the driver side DS, the switches S_{w1} are open (non-conductive) with the transmitter TX/DS enabled to transmit the signal IS2 while the switches S_{w1} are closed (conductive) and couple to the ground GND₂ the input nodes of the receiver RX/DS; and on the controller side CS, the switches S_{w1} are open (non-conductive) with the receiver RX/CS enabled to receive as OS2 the signal IS2 originated in the transmitter TX/DS while the switches S_{w2} are closed (conductive) and couple the output nodes of the transmitter TX/CS to the capacitors C₂ referred to ground GND₁.

In response to a certain (for instance, pre-determined) bit sequence being received by the receiver RX-CS on the controller side CS, the transmission direction over the link is inverted (reversed), with the generator SC switching the signals EN_{TR} and (NEG) EN_{TR} so that, in this reversed operating condition (transmission from the controller side CS to the driver side DS) the generator SC switches the signals EN_{TR} and (NEG) EN_{TR} applied to the switches S_{w1} and S_{w2} such that:
on the controller side CS, the switches S_{w2} are open (non-conductive) with the transmitter TX/CS enabled to transmit the signal IS1 while the switches S_{w1} are closed (conductive) and couple to the ground GND₁ the input nodes of the receiver RX/CS; and
on the driver side DS, the switches S_{w1} are open (non-conductive) with the receiver RX/DS enabled to receive as OS1 the signal IS1 originated in the transmitter TX/CS while the switches S_{w2} are closed (conductive) and couple the output nodes of the transmitter TX/CS to the capacitors C₂ referred to ground GND₂.

Transmission in the opposite direction (from the chip CS on the controller side to the chip DS on the driver side) takes place for a defined time slot.

At the end of this period, the link returns to the initial configuration (transmission from the chip DS on the driver side to the chip CS on the controller side).

The digital signal EN_{TR} drives the four couples of switches S_{w1}, S_{w2} for a desired direction of the communication link.

The circuit diagram of FIG. 7 provides further details of a possible implementation of embodiments of the present description that can be adopted on both sides (controller side CS and driver side DS) of a system as discussed herein.

For that reason, in the circuit diagram of FIG. 7, parts or elements already discussed in connection with the other figures are labeled by dropping the suffixes CS and DS that distinguish the chips DS and CS in figures such as FIG. 6.

In the circuit diagram of FIG. 7, a single transmitting/receiving (micro) antenna T/R is thus illustrated as a balanced series arrangements of two inductors having an inductance value L/2 (half of the inductance of the whole antenna totaling to a value L) with an intermediate node at a respective supply voltage V_{DD} (as noted, this supply voltage may be different, for instance, V_{DD1} and V_{DD2} in the chip CS and in the chip DS, respectively, the same also applying to the ground GND₁ for instance GND₁ and GND₂).

In the circuit diagram of FIG. 7:
the antenna T/R is configured as a LC (inductive-capacitive) resonant circuit with a capacitance Cₛᵣ coupled across (that is, in parallel to) the antenna T/R,
a transmitter TX has output nodes (directly) coupled at nodes A and B across the resonant circuit formed by the parallel arrangement of the antenna T/R and the capacitance Csr;
a receiver RX has input nodes coupled via a pair of capacitors C₁ to the nodes A and B across the resonant circuit formed by the parallel arrangement of the antenna T/R and the capacitance Csr;
first switches S_{w1} are provided that, when closed (namely, made conductive), couple to ground GND the input nodes of the receiver RX; and
second switches S_{w2} are provided that, when closed (namely, made conductive), place a capacitance C₂/2 in parallel to the inductance of the antenna (that acts a receiving antenna, in that case) and to the capacitance Csr; at the same time the switches S_{w1} are open with the receiver RX enabled to receive and the transmitter TX disabled thanks to an OR gate 12 that, based on NEG (EN_{TR}), keeps an oscillator in the transmitter TX turned off (with the switches 111 e 112 on, namely conductive).

That is, as illustrated in FIG. 7, the switches S_{w1} act at the receivers RX (on both sides, CS and DS) while the switches S_{w2} act at the transmitters TX (again, on both sides, CS and DS).

As represented (merely by way of example) in FIG. 7, the transmitter TX can be implemented with a pair of input transistors 111, 112 (for instance, MOSFET transistors) having their control terminals (gates in the case of field-effect transistors such as MOSFETs) jointly coupled to the output of the OR gate 12 that receives as inputs a data signal DATA_{IN} (IS1, IS2 in the diagram of FIG. 6) and the signal NEG (EN_{TR}) as a gating signal.

In that way, when the circuit is configured to act as a transmitter (for instance, with EN_{TR} “high” so that the receiver input is short-circuited to ground) the signal NEG (EN_{TR}) is “low” and the output from the OR gate 12 turns on and off the (transmitter) oscillator based on the signal DATA_{IN} to be transmitted, thus implementing an OOK modulation.

The transistors 111, 112 have the current flow paths therethrough (source-drain in the case of field-effect transistors such as MOSFETs) coupled between ground GND and the control terminal (gate in the case of a field-effect transistors such as a MOSFET transistor) of a respective transistor in a further pair of transistors 113, 114 (for instance, again MOSFET transistors).

More specifically, as represented by way of example in FIG. 7:
the transistors 111, 112 have the current flow paths therethrough coupled to the control terminals (gates in the case of field-effect transistors such as a MOSFET) of the transistors 113, 114 with the transistors 113, 144 in turn arranged with the current flow paths therethrough (source-drain in the case of field-effect transistors such as MOSFETs) coupled between ground GND and a respective one of the opposite antenna nodes A and B;
the control terminals (gates in the case of field-effect transistors such as a MOSFET) of the transistors 113, 114 are coupled via resistors 133, 134 to a node at a bias voltage VB; and
a pair of capacitors Cb are cross-coupled between the control terminal of each one of the transistors in the pair 113, 114 and the current flow-path of the other transistor in the pair 113, 114 at the nodes A and B respectively.

As illustrated in FIG. 7, the two MOSFET transistors 111, 112 act as control switches to turn on and off the core oscillator of the transmitter. The transmitter is turned off keeping these switches (always) on, namely conductive, via the output of the OR gate 12 when the circuit is enabled for reception and the transmitter is turned off. Conversely, when the circuit is enabled for transmission, the oscillator is turned on and off based on the logic level of the signal PWM_DATA_IN at one of the inputs of the OR gate 12 that is inverted at the output of the OR gate. In that way, an on-off key modulation is implemented (DATA high >>>switches 111 and 112 off, DATA low >>>switches 111 and 112 on). At the same time, the switches SW₁ are “on” (conductive) and short-circuit the inputs of the receiver by blanking it.

As likewise represented by way of example in FIG. 7, the receiver RX can comprise what is essentially an envelope detector comprising a differential arrangement of two transistors 221, 222 (for instance, MOSFET transistors) having their control terminals (gates in the case of field-effect transistors such as MOSFETs) coupled to the (antenna) nodes A and B via the capacitors C₁ and the current flow paths therethrough (source-drain in the case of field-effect transistors such as MOSFETs) coupled between ground GND and a resistor 223 referred to the supply node V_{DD}.

A node C between the transistors 221, 222 and the resistor 223 provides an output from the differential arrangement that is coupled (for instance, via a further amplifier 24 providing additional gain) to a (hysteresis) comparator 26 (having for instance a reference voltage set at VB) whose output is a PWM-modulated signal PWM_{OUT} (OS1, OS2 in the diagram of FIG. 6).

Such a PWM-modulated signal is suited to drive a load, for instance, to on-off turn an electronic switch such as a power MOSFET transistor (not visible: usually this may be distinct element from the embodiments).

It will be otherwise appreciated that the one presented in the circuit diagram of FIG. 7 is just one exemplary way of implementing a circuit where the switches S_{w1} and S_{w2} facilitate switching the circuit between a role in transmission and a role in reception using a radiofrequency, RF carrier at a frequency (pulsation) given by

$${ω}_{rf} = 1 / SQR T ( L {C}_{t o t} )$$

that is via an inductive-capacitive, LC resonant circuit formed by the inductive contribution L/2 of the (micro) antenna T/R and a total capacitance Cₜₒₜ.

In the exemplary arrangement of FIG. 7, such a total capacitance Cₜₒₜ can be expressed as:

$${C}_{t o t} = {C}_{s r} + {C}_{p a r} + {C}_{1 , 2} / 2$$

namely as the sum of:
a first contribution Cₛᵣ provided by the capacitor Cₛᵣ across the antenna nodes A and B;
a second contribution Cₚₐᵣ provided by parasitic capacitances due to layout connections and to the capacitive contributions of the MOSFET transistors 113 e 114: these may be fairly large transistors that provide a non-negligible capacitive contribution; and
a third contribution C_{1,2}/2 provided by the capacitors C₁ for the receiver RX and by the capacitors C₂ for the transmitter TX-when these capacitors are coupled to the circuit based on the on-off (conductive/non-conductive) condition of the switches Sw₁, Sw₂.

The third contribution is related to the fact that, irrespective of whether the circuit is configured as a transmitter (Tx) or a receiver (Rx), such a capacitance is arranged in parallel.

This plays a role in so far as the two resonating LC networks can be provided on opposite sides of the insulation barrier IB that are centered at a same resonating frequency (with, at each time instant, one of the two operating as a transmitter Tx and the other as a receiver Rx or vice-versa).

This counters undesired attenuation of the RF signal transmitted; the two capacitances C₂ facilitate balancing the capacitive load of the LC network when the circuit operates as a receiver Rx, by “tuning” its frequency with the LC network on the other side of the barrier IB that is configured to operate as a transmitter Tx.

The resonating frequency of the LC resonant circuit including the (micro) antenna T/R is a function of C_{1,2} and can thus be controlled acting on the switches Sw₁, Sw₂ via the signal EN_{TR}, NEG (EN_{TR}).

Switching such an LC resonant circuit from a role in transmission to a role in reception facilitates using this LC resonant circuit first as a resonator to create a transmitted RF carrier for transmission by the transmitter TX and then as a matching network at the same frequency for the input of the receiver circuit RX.

To summarize, a circuit as exemplified in FIG. 7 comprises:
an antenna T/R configured for transmitting and receiving radiofrequency signals,
a transmitter TX configured to receive an input data signal DATA_{IN} for transmission over a modulated radiofrequency, RF carrier signal at a carrier frequency via the antenna T/R, and a receiver RX configured to deliver an output data signal PWM_{OUT} in response to reception of a modulated radiofrequency carrier signal at the carrier frequency via the antenna T/R.

The RF carrier has a frequency (pulsation) given by

$${ω}_{rf} = 1 / SQR T ( L {C}_{t o t} )$$

where, L (L/2) in an inductive component provided by the antenna T/R, and, as discussed previously, Cₜₒₜ comprises (in addition to a first contribution Cₛᵣ provided by a capacitive component Cₛᵣ of the antenna T/R and a second contribution Cₚₐᵣ provided by parasitic capacitances—these components are inherent in the circuit) a third contribution C_{1,2}/2 provided by the capacitors C₁ and the capacitors C₂.

As discussed previously, the switches S_{w1}, S_{w2} are configured to be controlled by the signals EN_{TR} and NEG (EN_{TR}) in such a way that the capacitors C₁ and C₂ are coupled to the inductive-capacitive network of the antenna T/R alternately in a transmission mode and in a reception mode.

In the transmission mode, the first switches S_{w1} (on, and thus conductive) couple the first capacitors C₁ to ground GND. The receiver RX is disabled while the first capacitors C₁ are coupled to (that is included in) the inductive-capacitive network of the antenna.

Still in the transmission mode, the (non-conductive, “off”) second switches S_{w2} decouple the capacitors C₂ from the inductive-capacitive network of the antenna: in FIG. 7, with the switches S_{w2} open (non-conductive), the capacitors C₂ are essentially “dangling” from the nodes A and B and thus are not coupled to the inductive-capacitive network of the antenna

Conversely, in the reception mode, the first switches S_{w1} decouple the first capacitors C₁ from ground GND and the receiver RX is enabled.

Still in the reception mode, the second switches S_{w2} couple the second capacitors C₂ to the inductive-capacitive network with the transmitter TX disabled.

Such mode of operation facilitates obtaining a resonating frequency of the inductive-capacitive network of the antenna that matches a desired carrier frequency in both the transmission mode and the reception mode.

Embodiments as discussed herein facilitate package scale isolation with galvanic isolation implemented without using specific high-voltage components while also facilitating providing an inter-chip communication channel implemented via wireless RF transmission.

A judicious choice of the distance between two chips such as the chips CS and DS discussed previously facilitates achieving higher isolation rating (10-12 kV for reinforced isolation) and higher common mode transient immunity, CMTI higher than 100 kV, for instance; CMTI denotes a maximum tolerable rate of rise or fall of the common mode voltage applied between two isolated circuits.

Embodiments as discussed herein facilitate implementing half-duplex communication with a single pair of, for instance, near-field coupled (micro) antennas using only one physical link, thus saving occupation of semiconductor (silicon) area and reducing current consumptions without increasing circuit complexity.

In embodiments as discussed herein, opening and closing alternately certain sets of switches (S_{w1} and S_{w2}) facilitates matching of a circuit selected to receive or transmit the signals propagated via the (micro) antennas.

Embodiments as discussed herein do not require external or non-standard components and are suited for implementation via otherwise conventional CMOS integration technology.

FIG. 8 is a possible diagram of a system incorporating embodiments of the present description along the lines of FIG. 3 (already discussed) where communication between two chips CS and DS via a galvanic barrier IB may involve:
a pulse-width modulated, PWM driver link from the chip CS (here transmitter TX) to the chip DS (here receiver RX);
a bidirectional diagnostic data link between the chip CS and the chip DS (here capable of acting-alternately and alternatively—as a transmitter TX and as a receiver RX, for instance, by resorting to the circuit diagram detailed in FIG. 7); and
a power control link from the chip DS (here transmitter TX) to the chip CS (here receiver RX).

The references in FIG. 8 indicate the following elements:
control logic and diagnostics (controller side): 1001
I/O interface: 1002
monitor (controller side): 1003
internal low-voltage (LV) supply: 1004
driver: 1005
DVC: 1006
control logic and diagnostics (driver side): 2001
driver (power): 2002
monitor (driver side): 2003
internal high-voltage (HV) supply: 2004
analog-to-digital (ADC) converter: 2005
voltage regulator: 2006
voltage to PWM converter: 2006

The pin designations in FIG. 8 are well known to those of skill in the art: they are mentioned here merely by way of example and are not limitative of the embodiments.

Without prejudice to the underlying principles, the details and embodiments may vary, even significantly, with respect to what has been described in the foregoing, by way of example only, without departing from the extent of protection.

The extent of protection is determined by the annexed claims.

What is claimed is:

1. A circuit, comprising:
an antenna configured to transmit and receive radiofrequency signals;
a transmitter configured to receive an input data signal for transmission over a first modulated radiofrequency carrier signal at a carrier frequency via the antenna;
a receiver configured to deliver an output data signal in response to reception of a second modulated radiofrequency carrier signal at the carrier frequency via the antenna;
first capacitive circuitry arranged between the antenna and the receiver;
second capacitive circuitry arranged between the antenna and the transmitter;
first and second switching circuitry configured to couple the first and second capacitive circuitry, respectively, to the antenna in an inductive-capacitive network, wherein the first and second switching circuitry are configured to be switched, alternately:
in a transmission mode, wherein the first switching circuitry couples the first capacitive circuitry to a ground with the receiver disabled, and the second switching circuitry decouples the second capacitive circuitry from the inductive-capacitive network with the transmitter enabled; and
in a reception mode, wherein the first switching circuitry decouples the first capacitive circuitry from the ground, with the receiver enabled, and the second switching circuitry couples the second capacitive circuitry to the inductive-capacitive network with the transmitter disabled, wherein the inductive-capacitive network has a resonating frequency matching the carrier frequency in both the transmission mode and the reception mode.

2. The circuit of claim 1, wherein the inductive-capacitive network comprises:
the antenna providing an inductive component of the inductive-capacitive network; and
a capacitive component of the inductive-capacitive network including the first capacitive circuitry and the second capacitive circuitry coupled to the inductive-capacitive network via the first and second switching circuitry.

3. The circuit of claim 1, wherein:
the antenna has opposed first and second nodes;
the transmitter is configured to transfer the input data signal between the opposed first and second nodes as a modulation signal for transmission over the first modulated radiofrequency carrier signal; and
the receiver is configured to deliver the output data signal in response to reception of the second modulated radiofrequency carrier signal between the opposed first and second nodes.

4. The circuit of claim 1, wherein:
the antenna has opposed first and second nodes;
the first capacitive circuitry comprises a pair of first capacitors coupling one of the opposed first and second nodes of the antenna with a respective input of the receiver; and
the first switching circuitry comprises a pair of first switches each arranged between a respective input of the receiver and the ground.

5. The circuit of claim 1, wherein:
the antenna has opposed first and second nodes;
the second capacitive circuitry comprises a pair of second capacitors each coupled to one of the opposed first and second nodes of the antenna; and
the second switching circuitry comprises a pair of second switches each arranged between a respective one of the second capacitors and the ground.

6. The circuit of claim 1, wherein:
the antenna has opposed first and second nodes;
the transmitter is configured to transfer the input data signal between the opposed first and second nodes as a modulation signal for transmission over the first modulated radiofrequency carrier signal;
the receiver is configured to deliver the output data signal in response to reception of the second modulated radiofrequency carrier signal between the opposed first and second nodes;
the first capacitive circuitry comprises a pair of first capacitors coupling one of the opposed first and second nodes of the antenna with a respective input of the receiver;
the first switching circuitry comprises a pair of first switches each arranged between a respective input of the receiver and the ground;
the second capacitive circuitry comprises a pair of second capacitors each coupled to one of the opposed first and second nodes of the antenna; and
the second switching circuitry comprises a pair of second switches each arranged between a respective one of the second capacitors and the ground.

7. The circuit of claim 1, wherein the transmitter comprises an oscillator configured to be turned on and off based on a logic level of the input data signal.

8. A system, comprising:
a first circuit and a second circuit, each circuit comprising:
an antenna configured to transmit and receive radiofrequency signals;
a transmitter configured to receive an input data signal for transmission over a first modulated radiofrequency carrier signal at a carrier frequency via the antenna;
a receiver configured to deliver an output data signal in response to reception of a second modulated radiofrequency carrier signal at the carrier frequency via the antenna;
first capacitive circuitry arranged between the antenna and the receiver;
second capacitive circuitry arranged between the antenna and the transmitter;
first and second switching circuitry configured to couple the first and second capacitive circuitry, respectively, to the antenna in an inductive-capacitive network, wherein the first and second switching circuitry are configured to be switched, alternately:
in a transmission mode, wherein the first switching circuitry couples the first capacitive circuitry to a ground with the receiver disabled, and the second switching circuitry decouples the second capacitive circuitry from the inductive-capacitive network with the transmitter enabled; and
in a reception mode, wherein the first switching circuitry decouples the first capacitive circuitry from the ground, with the receiver enabled, and the second switching circuitry couples the second capacitive circuitry to the inductive-capacitive network with the transmitter disabled, wherein the inductive-capacitive network has a resonating frequency matching the carrier frequency in both the transmission mode and the reception mode;
wherein the first circuit and the second circuit are arranged on a first side and on a second side, respectively, of a galvanic isolation, and wherein the antennas in the first circuit and in the second circuit facilitate radiofrequency signal propagation through the galvanic isolation; and
switch control circuitry of the first and second switching circuitry in the first circuit and in the second circuit, respectively, the switch control circuitry configured to switch the system alternately between:
a) a first system state, wherein the second circuit is in the transmission mode and the first circuit is in the reception mode; and
b) a second system state, wherein the second circuit is in the reception mode and the first circuit is in the transmission mode.

9. The system of claim 8, further comprising:
a controller coupled to the first circuit on the first side of the galvanic isolation; and
a driver coupled to the second circuit on the second side of the galvanic isolation.

10. The system of claim 8, wherein the inductive-capacitive network in each circuit comprises:
the antenna providing an inductive component of the inductive-capacitive network; and
a capacitive component of the inductive-capacitive network including the first capacitive circuitry and the second capacitive circuitry coupled to the inductive-capacitive network via the first and second switching circuitry.

11. The system of claim 8, wherein, in each circuit:
the antenna has opposed first and second nodes;
the transmitter is configured to transfer the input data signal between the opposed first and second nodes as a modulation signal for transmission over the first modulated radiofrequency carrier signal; and
the receiver is configured to deliver the output data signal in response to reception of the second modulated radiofrequency carrier signal between the opposed first and second nodes.

12. The system of claim 8, wherein, in each circuit:
the antenna has opposed first and second nodes;
the first capacitive circuitry comprises a pair of first capacitors coupling one of the opposed first and second nodes of the antenna with a respective input of the receiver; and
the first switching circuitry comprises a pair of first switches each arranged between a respective input of the receiver and the ground.

13. The system of claim 8, wherein, in each circuit:
the antenna has opposed first and second nodes;
the second capacitive circuitry comprises a pair of second capacitors each coupled to one of the opposed first and second nodes of the antenna; and
the second switching circuitry comprises a pair of second switches each arranged between a respective one of the second capacitors and the ground.

14. The system of claim 8, wherein, in each circuit, the transmitter comprises an oscillator configured to be turned on and off based on a logic level of the input data signal.

15. A method of operating a system comprising a first circuit and a second circuit, arranged on a first side and on a second side, respectively, of a galvanic isolation, each circuit comprising an antenna, a transmitter, a receiver, first capacitive circuitry arranged between the antenna and the receiver, second capacitive circuitry arranged between the antenna and the transmitter, first and second switching circuitry configured to couple the first and second capacitive circuitry, respectively, to the antenna in an inductive-capacitive network, and switch control circuitry of the first and second switching circuitry in the first circuit and in the second circuit, respectively, the method comprising:
facilitating, by the antennas in the first circuit and in the second circuit, radiofrequency signal propagation through the galvanic isolation;
in each of the first and second circuits:
receiving, by the transmitter, an input data signal for transmission over a first modulated radiofrequency carrier signal at a carrier frequency via the antenna;
delivering, by the receiver, an output data signal in response to reception of a second modulated radiofrequency carrier signal at the carrier frequency via the antenna; and
switching the first and second switching circuitry, alternately, and oppositely with respect to the other circuit:
in a transmission mode, coupling, by the first switching circuitry, the first capacitive circuitry to a ground with the receiver disabled, and decoupling, by the second switching circuitry, the second capacitive circuitry from the inductive-capacitive network with the transmitter enabled; and
in a reception mode, decoupling, by the first switching circuitry, the first capacitive circuitry from the ground, with the receiver enabled, and coupling, by the second switching circuitry, the second capacitive circuitry to the inductive-capacitive network with the transmitter disabled, the inductive-capacitive network having a resonating frequency matching the carrier frequency in both the transmission mode and the reception mode; and
operating the switch control circuitry to switch the system alternately between:
a) a first system state in which the second circuit is in the transmission mode and the first circuit is in the reception mode; and
b) a second system state in which the second circuit is in the reception mode and the first circuit is in the transmission mode.

16. The method of claim 15, comprising:
selecting the first system state as a default system state;
switching the system from the first system state to the second system state in response to receiving, at the receiver in a respective one of the first circuit and the second circuit in the first system state, a first output data signal matching a bit sequence pattern;
maintaining the system in the second system state during a time interval having an expiry time; and
switching the system from the second system state back to the first system state in response to the time interval reaching the expiry time.

17. The method of claim 15, wherein, in each of the first and second circuits, the antenna has opposed first and second nodes, and the method further comprises:
transferring, by the transmitter, the input data signal between the opposed first and second nodes as a modulation signal for transmission over the first modulated radiofrequency carrier signal.

18. The method of claim 17, the method further comprising, in each of the first and second circuits:
delivering, by the receiver, the output data signal in response to reception of the second modulated radiofrequency carrier signal between the opposed first and second nodes.

19. The method of claim 15, further comprising:
providing, by a controller coupled to the first circuit on the first side of the galvanic isolation, the input data signal to the transmitter; and
receiving, by a driver coupled to the second circuit on the second side of the galvanic isolation, the output data signal.

20. The method of claim 15, further comprising turning on and off, in each transmitter, an oscillator based on a logic level of the input data signal.
